(19) United States
(12) Patent Application Publication
(10) Pub. No.: US 2017/0083286 A1
(43) Pub. Date: Mar. 23, 2017

(54) PARALLEL MERGE SORTING

(71) Applicant: Huawei Technologies Co., Ltd., Shenzhen (CN)

(72) Inventors: Mahesh Kumar BEHERA, Bangalore (IN); Prasanna Venkatesh RAMAMURTHI, Bangalore (IN); Antoni WOLSKI, Helsinki (FI)

(21) Appl. No.: 15/365,463

(22) Filed: Nov. 30, 2016

Related U.S. Application Data
(63) Continuation of application No. PCT/EP2014/061269, filed on May 30, 2014.

(51) Int. Cl. G06F 7/36; G06F 3/06

(52) U.S. Cl. CPC G06F 7/36; G06F 3/0611; G06F 3/0644; G06F 3/064; G06F 3/065; G06F 3/067

(57) ABSTRACT

The invention relates to a sorting method (1100), the sorting method comprising: sorting (1101) the distributed input data locally per processing node (701, 702) by deploying first processes on the processing nodes (701, 702) to produce a plurality of sorted lists on the local memory partitions (401, 402, 403, 404) of the processing nodes (701, 702); creating (1102) a sequence of range blocks (703, 704, 713, 714) on the local memory partitions of the processing nodes (701, 702), copying (1103) the plurality of sorted lists to the sequence of range blocks (703, 704, 713, 714); and reading (1105) the sorted elements from the sequence of range blocks (703, 704, 713, 714) sequentially with respect to their range to obtain the sorted input data.

### CROSS-REFERENCE TO RELATED APPLICATIONS

This application is a continuation of International Application No. PCT/EP2014/061269, filed on May 30, 2014, the disclosure of which is hereby incorporated by reference in its entirety.

### TECHNICAL FIELD

The present disclosure relates to a sorting method and a processing system comprising a plurality of interconnected processing nodes for sorting input data distributed over the processing nodes. The disclosure further relates to computer hardware characterized by asymmetric memory and a parallel sorting method for such asymmetric memory.

### BACKGROUND

On modern computer hardware 100 characterized by asymmetric memory for each execution unit, e.g. processor 101, 103 and core 109, 119, all memory locations are divided into local 107 (with respect to node 0 101) and remote 117 memory, as shown in FIG. 1. The access 108 to the local memory 107 is faster than to the remote memory 117 because of the different lengths of the physical access path 102, as illustrated in FIG. 1. The problem introduced by asymmetric memory is that, in computing methods being agnostic to memory asymmetry, execution costs are higher than those that can be achieved with optimized use of local and remote memory.

Sorting is considered to be one of the basic operations used in many fields of computing. For example, the need for sorting in asymmetric memory is evident while sorting query results produced by parallel query methods in database systems. SQL (Structured Query Language) clauses “ORDER BY” and “GROUP BY” require such sorting. Some join methods, like sort-merge join also require sorting. There are many algorithms that make use of multiple cores of a system to make the sorting parallel and improve the performance. But none of these algorithms takes the asymmetry of the memory architectures into consideration. Currently, in sorting algorithms, the data is partitioned randomly and different threads are allowed to work on this data randomly. This leads to the excessive use of remote access and the socket interconnection, and thus can severely limit the system throughput.

Modern processors 200 employ multi cores 201, 202, 203, 204, main memory 205 and several levels of memory caches 206, 207, 208 as illustrated in FIG. 2. Current sorting algorithms, e.g. as described by U.S. Pat. No. 8,332,595 B2, U.S. Pat. No. 6,427,148 B1, U.S. Pat. No. 5,852,826 A and U.S. Pat. No. 7,536,432 B2 do not address the problems of data locality and cache-consciousness. That leads to frequent cache misses and inefficient execution. Processors are equipped with SIMD (single-instruction, multiple-data) hardware that allows performing so-called vectorized processing, that is, executing the same operation on a series of closely adjacent data. Current sorting methods are not optimized for SIMD.

### SUMMARY

It is the object of the invention to provide an improved sorting technique.

This object is achieved by the features of the independent claims. Further implementation forms are apparent from the dependent claims, the description and the figures.

The invention as described in the following is based on the finding that an improved sorting technique can be provided by taking advantage of the differences in asymmetric memory access latency to reduce the memory access cost significantly in highly memory-access-intensive sorting algorithms.

In order to describe the invention in detail, the following terms, abbreviations and notations will be used:
DBMS: Data Base Management System.
SQL: Structured Query Language.
CPU: Central Processing Unit.
SIMD: Single Instruction, Multiple Data.
NUMA: Non-Uniform Memory Access.

Database management systems (DBMSs) are specially designed applications that interact with the user, other applications, and the database itself to capture and analyze data. A general-purpose database management system (DBMS) is a software system designed to allow the definition, creation, querying, update, and administration of databases. Different DBMSs can interoperate by using standards such as SQL and ODBC or JDBC to allow a single application to work with more than one database.

SQL (Structured Query Language) is a special-purpose programming language designed for managing data held in a relational database management system (RDBMS).

Originally based upon relational algebra and tuple relational calculus, SQL consists of a data definition language and a data manipulation language. The scope of SQL includes data insert, query, update and delete, schema creation and modification, and data access control.

Single instruction, multiple data (SIMD), is a class of parallel computers in a classification of computer architectures. It describes computers with multiple processing elements that perform the same operation on multiple data points simultaneously. Thus, such machines exploit data level parallelism, for example, array processors or GPUs.

According to a first aspect, the invention relates to a sorting method for sorting input data distributed over local memory partitions of a plurality of interconnected processing nodes, the sorting method comprising: sorting the distributed input data locally per processing node by deploying first processes on the processing nodes to produce a plurality of sorted lists on the local memory partitions of the processing nodes; creating a sequence of range blocks on the local memory partitions of the processing nodes, wherein each range block is configured to store data values falling within its range; copying the plurality of sorted lists to the sequence of range blocks by deploying second processes on the processing nodes, wherein each range block receives elements of the sorted lists which values are falling within its range; sorting the elements of the range blocks locally per processing node by using the second processes to produce sorted elements on the range blocks; and reading the sorted elements from the sequence of range blocks sequentially with respect to their range to obtain the sorted input data.

The efficiency of such sorting algorithm is improved due to the use of local data access to a large extend thereby avoiding remote access penalty. Creating a sequence of range blocks on the local memory partitions of the processing nodes allows using sequential access to data instead of random access which improves access locality and cache efficiency. Especially in the case of remote access, using sequential access leverages pre-fetching that counterbalances the remote access penalty. Using vectors of adjacent data items in computing allows making use of SIMD.

In a first possible implementation form of the sorting method according to the first aspect, the local memory partitions of the plurality of interconnected processing nodes are structured as asymmetric memory.

Using sequential access to data instead of random access improves access locality and cache efficiency on asymmetric memory.

In a second possible implementation form of the sorting method according to the first aspect as such or according to the first implementation form of the first aspect, a number of first processes is equal to a number of local memory partitions.

When a number of first processes is equal to a number of local memory partitions each local memory partition can be processed in parallel by a respective first process thereby increasing the processing speed.

In a third possible implementation form of the sorting method according to the first aspect as such or according to any of the preceding implementation forms of the first aspect, the first processes produce disjoint sorted lists.

When the first processes produce disjoint sorted lists, local sorting in one list can be performed without accessing the other lists. That increases processing efficiency.

In a fourth possible implementation form of the sorting method according to the first aspect as such or according to any of the preceding implementation forms of the first aspect, the sorting the distributed input data locally per processing node is based on one of a serial sorting procedure and a parallel sorting procedure.

Usage, in the sorting steps, of local-only memory access decreases the inter-socket communication overhead and thus reduces computational complexity and increases performance of the sorting method.

In a fifth possible implementation form of the sorting method according to the first aspect as such or according to any of the preceding implementation forms of the first aspect, a number of second processes is equal to a number of range blocks.

When a number of second processes is equal to a number of range blocks each range block can be processed in parallel by a respective second process thereby increasing the processing speed.

In a sixth possible implementation form of the sorting method according to the first aspect as such or according to any of the preceding implementation forms of the first aspect, each range block has a different range.

When each range block has a different range, each memory partition can operate on different data thereby allowing parallel processing which increases the processing speed.

In a seventh possible implementation form of the sorting method according to the first aspect as such or according to any of the preceding implementation forms of the first aspect, each range block receives a plurality of sorted lists, in particular a number of sorted lists corresponding to the number of first processes.

Data in a similar range from different processing nodes can thus be concentrated on one processing node which improves the computational efficiency of the method.

In an eighth possible implementation form of the sorting method according to the first aspect as such or according to any of the preceding implementation forms of the first aspect, a second process of the second processes running on one processing node reads sequentially from the local memory of the one processing node and from the local memory of the other processing nodes when copying the plurality of sorted lists to the sequence of range blocks.

Usage, in the copy step, of sequential remote memory access reduces the remote access penalty.

In a ninth possible implementation form of the sorting method according to the eighth implementation form of the first aspect, the second process running on the one processing node writes only to the local memory of the one processing node when copying the plurality of sorted lists to the sequence of range blocks.

Thus, the second process does not have to wait for intersocket connection response when writing to memory.

In a tenth possible implementation form of the sorting method according to the first aspect as such or according to any of the preceding implementation forms of the first aspect, the sequential reading of the sorted elements from the sequence of range blocks is performed by utilizing hardware pre-fetching.

Utilizing hardware pre-fetching increases the processing speed.

In an eleventh possible implementation form of the sorting method according to the first aspect as such or according to any of the preceding implementation forms of the first aspect, the second processes use vectorized processing, in particular vectorized processing running on Single Instruction Multiple Data hardware blocks, for comparing values of the sorted lists with ranges of the range blocks and for copying the plurality of sorted lists to the sequence of range blocks.

Use of vectorized processing such as SIMD during the sorting steps improves the sort performance. Use of vectorized processing such as SIMD while copying allows utilizing the full memory bandwidth.

In a twelfth possible implementation form of the sorting method according to the first aspect as such or according to any of the preceding implementation forms of the first aspect, the plurality of processing nodes are interconnected by intersocket connections; and a local memory of one processing node is a remote memory to another processing node.

The method may be implemented on standard hardware architectures using asymmetric memory interconnected by intersocket connections. The method may be applied on multi core and many core processor platforms.

According to a second aspect, the invention relates to a processing system, comprising: a plurality of interconnected processing nodes each comprising a local memory and a processing unit, wherein input data is distributed over the local memories of the processing nodes and wherein the processing units are configured: to sort the distributed input data locally per processing node to produce a plurality of sorted lists on the local memories of the processing nodes, to create a sequence of range blocks on the local memories of the processing nodes, each range block being configured to store data values falling within its range, to copy the plurality of sorted lists to the sequence of range blocks, each range block receiving elements of the sorted lists which values are falling within its range, to sort the elements of the range blocks locally per processing node to produce sorted elements on the range blocks; and to read the sorted elements from the sequence of range blocks sequentially with respect to their range to obtain sorted input data.

Such new processing system for sorting distributed input data is able to sort a large set of randomly distributed values thereby maximizing the hardware resource utilization efficiency.

According to a third aspect, the invention relates to a computer program product comprising a readable storage medium storing program code thereon for use by a computer, the program code sorting input data distributed over local memory partitions of a plurality of interconnected processing nodes, the program code comprising: instructions for sorting the distributed input data locally per processing node by using first processes running on the processing nodes to produce a plurality of sorted lists on the local memory partitions of the processing nodes; instructions for creating a sequence of range blocks on the local memory partitions of the processing nodes, wherein each range block is configured to store data values falling within its range; instructions for copying the plurality of sorted lists to the sequence of range blocks by using second processes, wherein each range block receives elements of the sorted lists which values are falling within its range; instructions for sorting the elements of the range blocks locally per processing node by using the second processes to produce sorted elements on the range blocks; and instructions for reading the sorted elements from the sequence of range blocks sequentially with respect to their range to obtain the sorted input data.

The computer program can be flexibly designed such that an update of the requirements is easy to achieve. The computer program product may run on a multi core and many core processing system.

Aspects of the invention thus provide an improved sorting technique as further described in the following.

### BRIEF DESCRIPTION OF THE DRAWINGS

Further embodiments of the invention will be described with respect to the following figures, in which:

FIG. 1 shows a schematic diagram illustrating a modern computer hardware 100 according to an implementation form.

FIG. 2 shows a schematic diagram illustrating Modern processors 200 according to an implementation form.

FIG. 3 shows a schematic diagram illustrating an exemplary sorting method 300 according to an implementation form.

FIG. 4 shows a schematic diagram illustrating an exemplary partitioning act 301 of the sorting method 300 depicted in FIG. 3 according to an implementation form.

FIG. 5 shows a schematic diagram illustrating an exemplary local partition sorting act 302 of the sorting method 300 depicted in FIG. 3 according to an implementation form.

FIG. 6 shows a schematic diagram illustrating an exemplary thread deployment act 303a within an extracting and sorting act 303 of the sorting method 300 depicted in FIG. 3 according to an implementation form.

FIG. 7 shows a schematic diagram illustrating an exemplary extracting and sorting act 303 of the sorting method 300 depicted in FIG. 3 according to an implementation form.

FIG. 8 shows a schematic diagram illustrating an exemplary local range sorting act 304 of the sorting method 300 depicted in FIG. 3 according to an implementation form.

FIG. 9 shows a schematic diagram illustrating an exemplary merging act 305 of the sorting method 300 depicted in FIG. 3 according to an implementation form.

FIG. 10 shows a schematic diagram illustrating an exemplary method 1000 of sorting query results in a database management system using parallel query processing over partitioned data.

FIG. 11 shows a schematic diagram illustrating an exemplary sorting method 1100 according to an implementation form.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

The devices and methods described herein may be based on sorting distributed input data, local memory partitions and interconnected processing nodes. It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

The methods and devices described herein may be implemented in hardware architectures including asymmetric memory and data base management systems, in particular DBMS using SQL. The described devices and systems may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

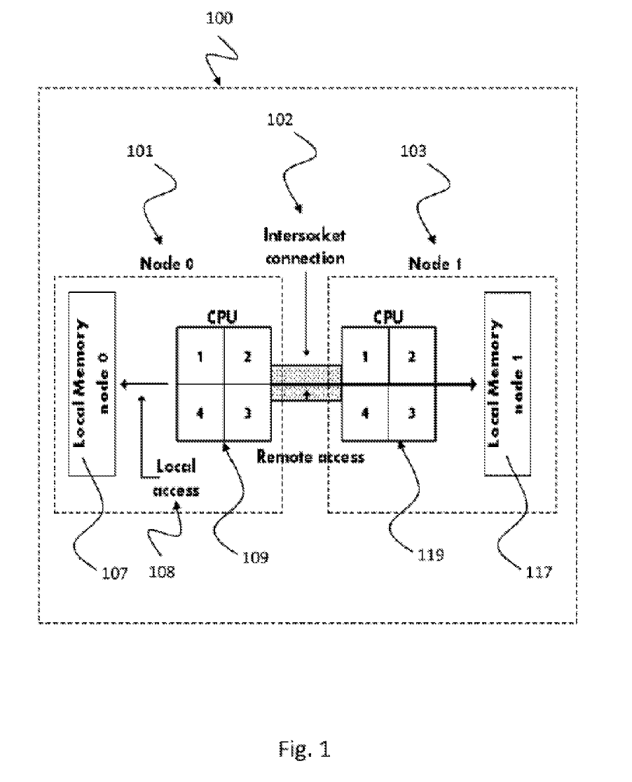

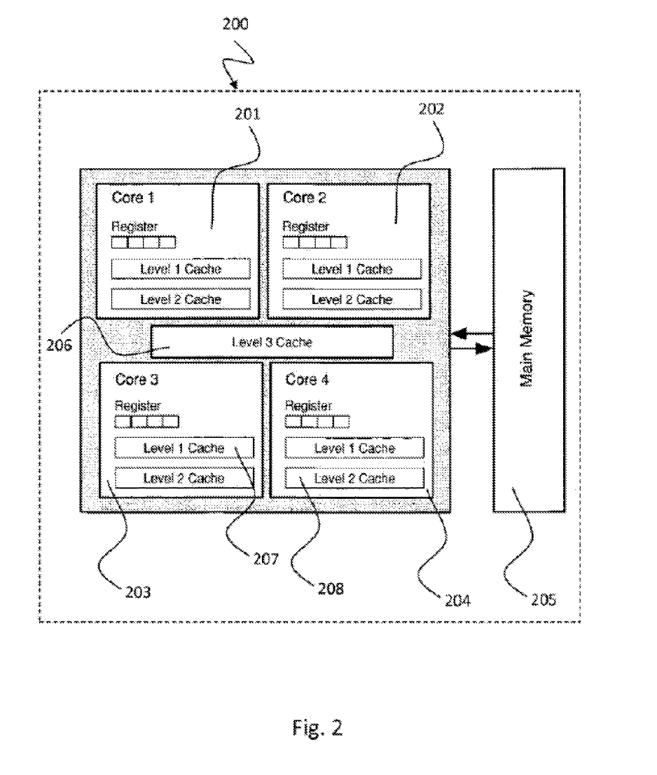

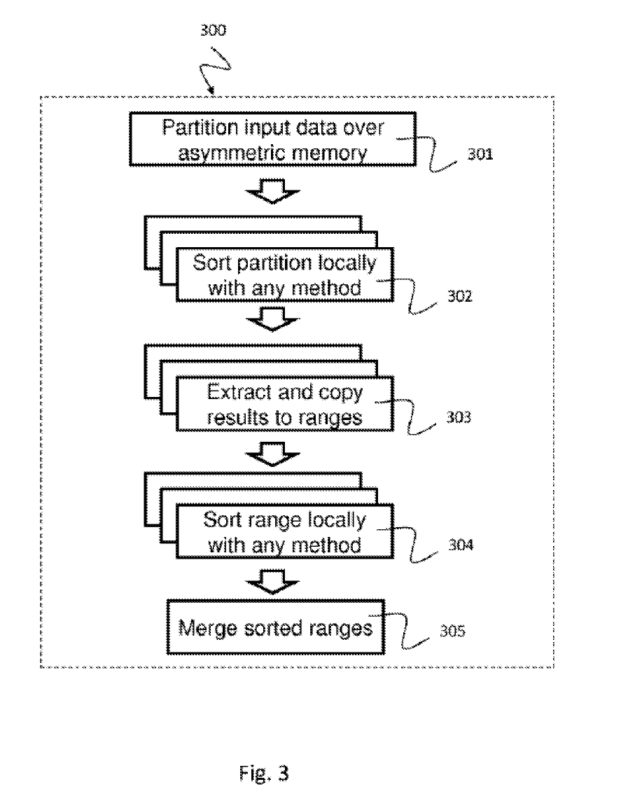

FIG. 3 shows a schematic diagram illustrating an exemplary sorting method 300 for sorting input data distributed over local memory partitions 107, 117 of a plurality of interconnected processing nodes 101, 103, e.g. of a hardware system 100, 200 described above with respect to FIG. 1 and FIG. 2 according to an implementation form.

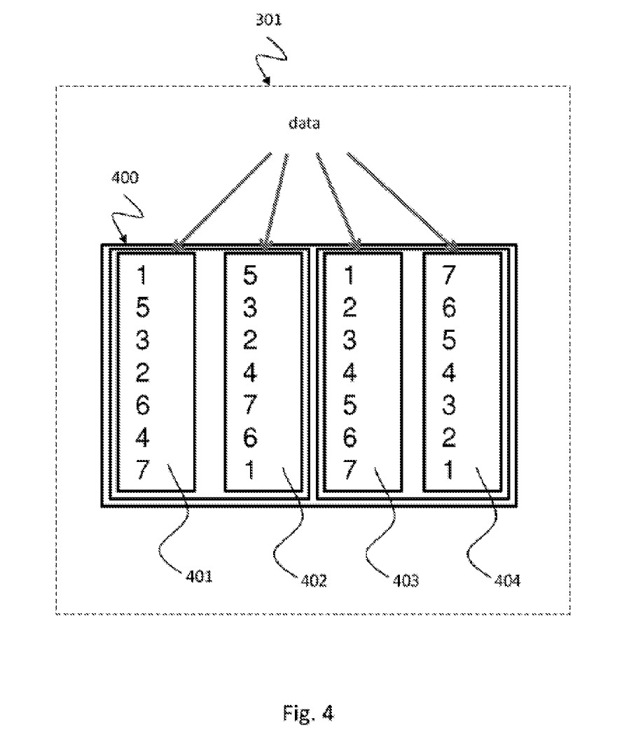

The sorting method 300 may include partitioning 301 the distributed input data over asymmetric memory obtaining multiple memory partitions. The sorting method 300 may include sorting 302 the memory partitions locally, e.g. by using any known local sorting method. The sorting act 302 may be performed for each memory partition. The sorting method 300 may include extracting and copying 303 results of the local sorting 302 to ranges, i.e. memory sections configured to store data falling within specific ranges. The extracting and copying act 303 may be performed for each memory partition. The sorting method 300 may include sorting 304 each range locally, e.g. by using any known local sorting method. The sorting act 304 may be performed for each range. The sorting method 300 may include merging 305 the sorted ranges. The different sorting steps or acts are further described below with respect to FIGS. 4 to 9.

The method 300 described in this disclosure may sort a large set of randomly distributed values within five steps and may therefore be able to maximize the hardware resource utilization efficiency. This method 300 takes advantage of differences in asymmetric memory access latency, to reduce the memory access cost significantly in highly memory-access-intensive algorithms like sorting.

FIG. 4 shows a schematic diagram illustrating an exemplary partitioning act 301 of the sorting method 300 depicted in FIG. 3 according to an implementation form.

Input data is partitioned over asymmetric memory 400. The input data is distributed over the memory banks 401, 402, 403, 404 of the asymmetric memory 400. This partitioning step 301 may be optional because most parallel data processing methods, like parallel query processing methods, produce the partitioned data.

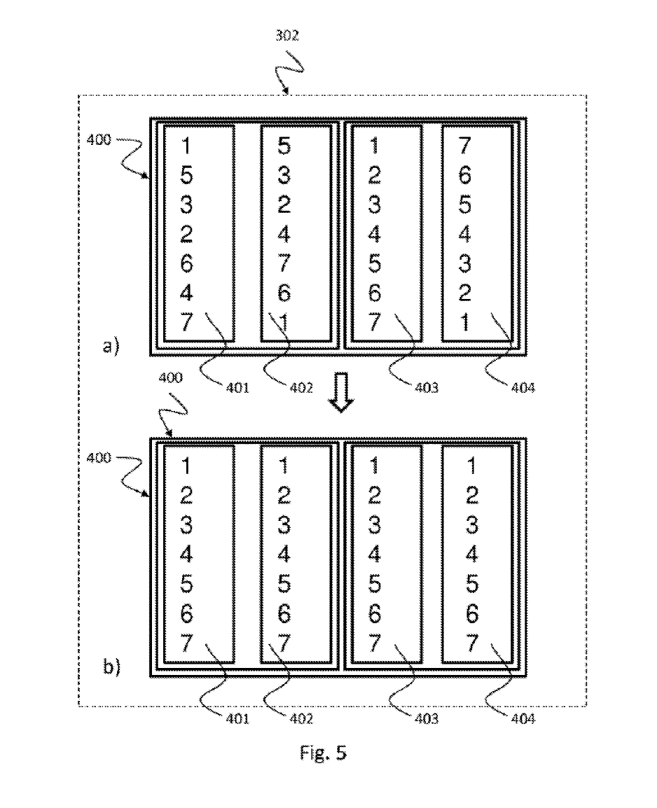

FIG. 5 shows a schematic diagram illustrating an exemplary local partition sorting act 302 of the sorting method 300 depicted in FIG. 3 according to an implementation form.

Threads are deployed to sort the data locally. Data “1,5,3,2,6,4,7” on first memory bank 401 is sorted locally on first memory bank 401 providing sorted data “1,2,3,4,5,6,7”. Data “5,3,2,4,7,6,1” on second memory bank 402 is sorted locally on second memory bank 402 providing sorted data “1,2,3,4,5,6,7”. Data “1,2,3,4,5,6,7” on third memory bank 403 is sorted locally on third memory bank 403 providing sorted data “1,2,3,4,5,6,7”. Data “7,6,5,4,3,2,1” on fourth memory bank 404 is sorted locally on fourth memory bank 404 providing sorted data “1,2,3,4,5,6,7”.

The number of threads may be equal to the number of partitions (Four partitions 401, 402, 403, 404 are shown in FIG. 5, but any other number is possible). All the threads may produce disjoint sorted lists that may be merged as described below, to get the final sorted output. Any sorting method can be used for the sorting act 302, serial or parallel. Local access is fully utilized.

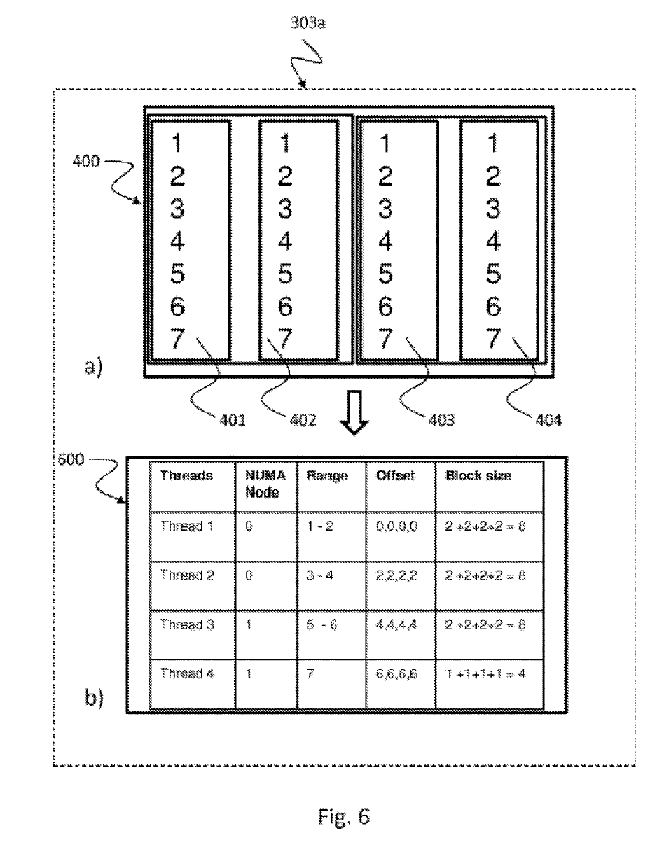

FIG. 6 shows a schematic diagram illustrating an exemplary thread deployment act 303a within an extracting and sorting act 303 of the sorting method 300 depicted in FIG. 3 according to an implementation form.

Based on the data sample, a range set 600 may be created, which may be used to distribute the sorted data among different threads. The range may be a subset of input data containing values of a given value range, e.g. ranging from 1 to 7 in the example of FIG. 6. The ranges may be calculated to be of (approximately) the same size. This may be achieved with a value distribution histogram obtained with sampling performed during the sorting phase. The ranges may be calculated based on data from all the partitions 401, 402, 403, 404. In FIG. 6 four ranges are created, a first range including data values 1 and 2, a second range including data values 3 and 4, a third range including data values 5 and 6 and a fourth range including data value 7.

The number of threads, e.g. 4 according to FIG. 6, but any other number is possible, may be the same as the number of ranges. A first thread “Thread 1” is associated to the first range, a second thread “Thread 2” is associated to the second range, a third thread “Thread 3” is associated to the third range and a fourth thread “Thread 4” is associated to the fourth range.

Based on the number of ranges the same number of range blocks of memory may be created in different memory banks. The number of range blocks in each memory bank may be the same to make use of all the cores being available.

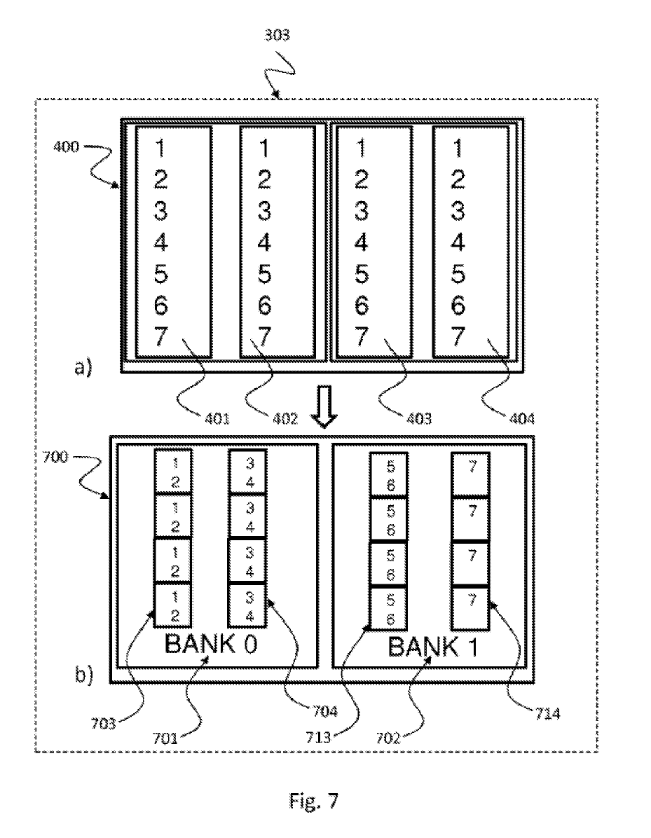

FIG. 7 shows a schematic diagram illustrating an exemplary extracting and sorting act 303 of the sorting method 300 depicted in FIG. 3 according to an implementation form.

The threads may be deployed to copy the data from the sorted lists 401, 402, 403, 404 to the newly created range blocks 703, 704, 713, 714 based on the value. As a result, each range block 703, 704, 713, 714 will have multiple sorted lists within a given value range. In the example of FIG. 7, a first range block 703 in memory bank 0, 701 includes data values 1 and 2, a second range block 704 in memory bank 0, 701 includes data values 3 and 4, a third range block 713 in memory bank 1, 702 includes data values 4 and 5 and a fourth range block 714 in memory bank 1, 702 includes data value 7. Threads may write only to local memory and may read sequentially from both local and remote memory. While performing value comparisons, the threads may use adjacent serial data. The advantage of SIMD may be utilized.

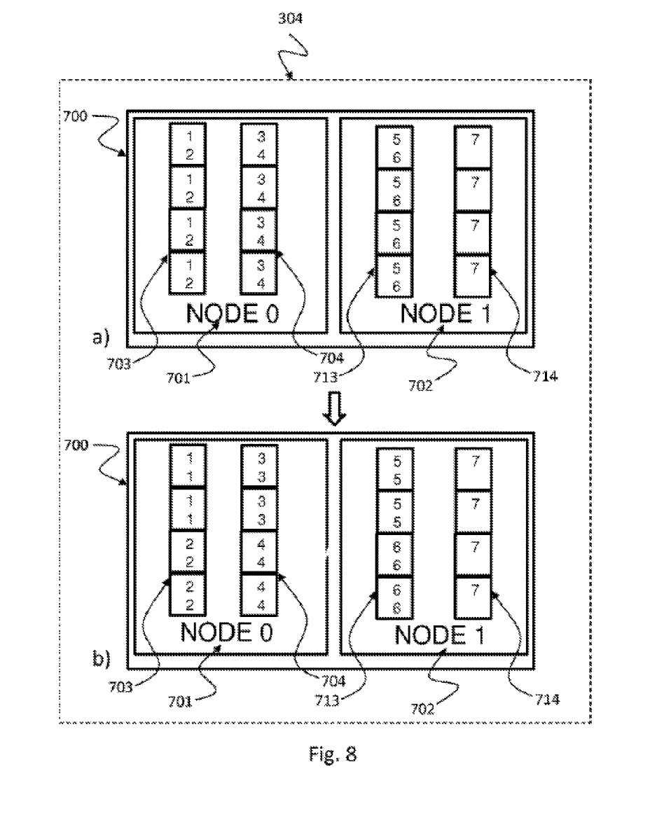

FIG. 8 shows a schematic diagram illustrating an exemplary local range sorting act 304 of the sorting method 300 depicted in FIG. 3 according to an implementation form.

The same threads (one per range block) may be applied as described above with respect to FIGS. 6 and 7 to perform an in-place sort of the data copied. The first range block 703 in memory bank 0 that may be implemented on node 0, 701 may sort data from “12121212” to “11112222”, e.g. by using Thread 0. The second range block 704 in memory bank 0 that may be implemented on node 0, 701 may sort data from “34343434” to “33334444”, e.g. by using Thread 1. The third range block 713 in memory bank 1 that may be implemented on node 1, 702 may sort data from “56565656” to “55556666”, e.g. by using Thread 3. The fourth range block 714 in memory bank 1 that may be implemented on node 1, 702 may sort data from “7777” to “7777”, e.g. by using Thread 3.

As a result, each block 703, 704, 713, 714 may have sorted data in the specific range. The local sort may be performed with any known sorting method, e.g. serial or parallel. The locality of data access may be fully utilized. The organization of data may help to utilize SIMD for comparison and copying.

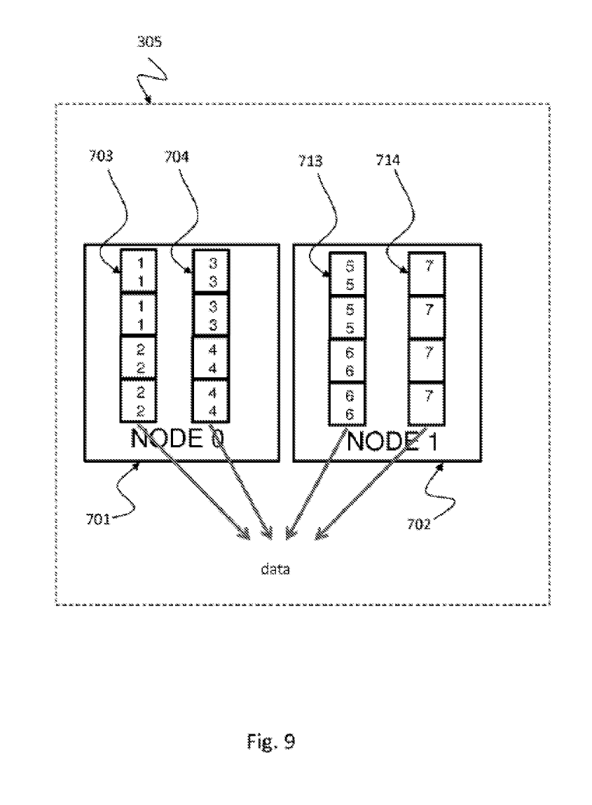

FIG. 9 shows a schematic diagram illustrating an exemplary merging act 305 of the sorting method 300 depicted in FIG. 3 according to an implementation form.

To obtain the sorted results, iteration may be performed over the sequence of range blocks 703, 704, 713, 714 and the data may be read. The data may be read sequentially, both from the local 701 and remote 702 locations and thus reducing the impact of socket-to-socket communication by utilizing hardware pre-fetching.

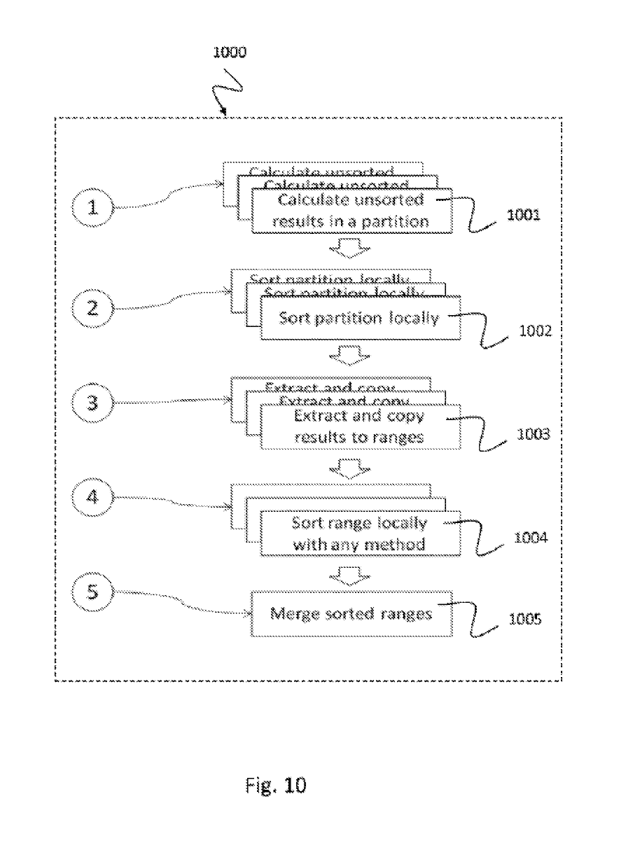

FIG. 10 shows a schematic diagram illustrating an exemplary method 1000 of sorting query results in a database management system using parallel query processing over partitioned data.

FIG. 10 describes a specific method of sorting query results in a database management system involving parallel query processing over partitioned data. An example query may be expressed with an SQL statement being of the form “SELECT A, . . . FROM table WHERE . . . ORDER BY A”. The method 1000 may apply to the execution of the ORDER BY clause. The query processor may produce, in parallel worker threads, unsorted results written to local memory (a partition) of each thread. This is illustrated by step 1 in FIG. 10.

In step 2, each unsorted partition may be sorted locally by a dedicated thread. In step 3, the data may be repartitioned in such a way that (a) the data value ranges are calculated to contain approximately equal amount of data, (b) the data value range partitions are allocated to memory that is local to worker threads, and (c) the range partitions are populated with the data matching the range by each worker thread sequentially scanning the sorted partitions produced in step 2 and extracting the relevant data. In step 4, each range may be sorted locally, producing a properly sorted part of the result set (result partition). In step 5, the result set parts may be merged by linking the result partitions in a proper order and reading the result partitions sequentially in that order.

In one example, the method 1000 may be applied to perform sorting in a database management system in the process of executing an SQL query having the JOIN clause, or expressed as implicit join. In that case, the steps 2 to 4 above may be applied to sort input tables in the context of the merge-join method.

In another example, the method 1000 may be applied to perform sorting in a database management system in the process of executing an SQL query having the GROUP BY clause. In that case, the steps 2 to 4 above may be applied to sort the aggregate calculation results (groups).

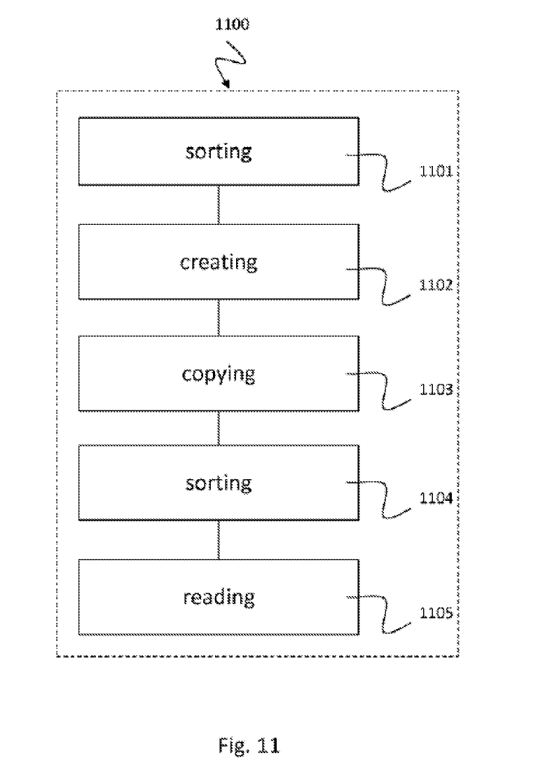

FIG. 11 shows a schematic diagram illustrating an exemplary sorting method 1100 for sorting input data distributed over local memory partitions of a plurality of interconnected processing nodes according to an implementation form.

The method 1100 may include sorting 1101 the distributed input data locally per processing node by deploying first processes on the processing nodes to produce a plurality of sorted lists on the local memory partitions of the processing nodes. The method 1100 may include creating 1102 a sequence of range blocks on the local memory partitions of the processing nodes, wherein each range block is configured to store data values falling within its range. The method 1100 may include copying 1103 the plurality of sorted lists to the sequence of range blocks by deploying second processes on the processing nodes, wherein each range block receives elements of the sorted lists which values are falling within its range. The method 1100 may include sorting 1104 the elements of the range blocks locally per processing node by using the second processes to produce sorted elements on the range blocks. The method 1100 may include reading 1105 the sorted elements from the sequence of range blocks sequentially with respect to their range to obtain the sorted input data.

The sorting 1101 may correspond to the sorting 302 the memory partitions locally as described above with respect to FIG. 3. The creating 1102 and copying 1103 may correspond to the extracting and copying act 303 as described above with respect to FIG. 3. The sorting 1104 may correspond to the sorting 304 each range locally as described above with respect to FIG. 3. The reading 1105 may correspond to the merging 305 the sorted ranges as described above with respect to FIG. 3.

In one example, the local memory partitions of the plurality of interconnected processing nodes may be structured as asymmetric memory. In one example, a number of first processes may be equal to a number of local memory partitions. In one example, the first processes may produce disjoint sorted lists. In one example, the sorting the distributed input data locally per processing node may be based on one of a serial sorting procedure and a parallel sorting procedure. In one example, a number of second processes may be equal to a number of range blocks. In one example, each range block may have a different range. In one example, each range block may receive a plurality of sorted lists, in particular a number of sorted lists corresponding to the number of first processes. In one example, a second process of the second processes running on one processing node may read sequentially from the local memory of the one processing node and from the local memory of the other processing nodes when copying the plurality of sorted lists to the sequence of range blocks. In one example, the second process running on the one processing node may write only to the local memory of the one processing node when copying the plurality of sorted lists to the sequence of range blocks. In one example, the sequential reading of the sorted elements from the sequence of range blocks may be performed by utilizing hardware pre-fetching. In one example, the second processes may use vectorized processing, in particular vectorized processing running on Single Instruction Multiple Data hardware blocks, for comparing values of the sorted lists with ranges of the range blocks and for copying the plurality of sorted lists to the sequence of range blocks. In one example, the plurality of processing nodes may be interconnected by intersocket connections and a local memory of one processing node may be a remote memory to another processing node.

The invention includes a method making use of the difference in access time for the different memory bank in a system. This may be achieved by minimal use of the socket to socket communication link. Until today, no method has been deployed to sort a randomly arranged data which minimizes the random access of data across different sockets. By using measurement tools, the data flow across the sockets and the access patterns may be determined for a sort operation.

The methods, systems and devices described herein may be implemented as software in a Digital Signal Processor (DSP), in a micro-controller or in any other side-processor or as hardware circuit within an application specific integrated circuit (ASIC).

The invention can be implemented in digital electronic circuitry, or in computer hardware, firmware, software, or in combinations thereof, e.g. in available hardware of conventional mobile devices or in new hardware dedicated for processing the methods described herein.

The present disclosure also supports a computer program product including computer executable code or computer executable instructions that, when executed, causes at least one computer to execute the performing and computing steps described herein, in particular the methods 300 as described above with respect to FIGS. 3 to 9 and the methods 1000, 1100 described above with respect to FIGS. 10 and 11. Such a computer program product may include a readable storage medium storing program code thereon for use by a computer. The program code may be configured to sort input data distributed over local memory partitions of a plurality of interconnected processing nodes. The program code may include instructions for sorting the distributed input data locally per processing node by using first processes running on the processing nodes to produce a plurality of sorted lists on the local memory partitions of the processing nodes; instructions for creating a sequence of range blocks on the local memory partitions of the processing nodes, wherein each range block is configured to store data values falling within its range; instructions for copying the plurality of sorted lists to the sequence of range blocks by using second processes, wherein each range block receives elements of the sorted lists which values are falling within its range; instructions for sorting the elements of the range blocks locally per processing node by using the second processes to produce sorted elements on the range blocks; and instructions for reading the sorted elements from the sequence of range blocks sequentially with respect to their range to obtain the sorted input data.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the present inventions has been described with reference to one or more particular embodiments, those skilled in the art recognize that many changes may be made thereto without departing from the scope of the present invention. It is therefore to be understood that within the scope of the appended claims and their equivalents, the invention may be practiced otherwise than as specifically described herein.

What is claimed is:

1. A sorting method (1100) for sorting input data distributed over local memory partitions (401, 402, 403, 404) of a plurality of interconnected processing nodes (701, 702), the sorting method comprising:
sorting (1101) the distributed input data locally per processing node (701, 702) by deploying first processes on the processing nodes (701, 702) to produce a plurality of sorted lists on the local memory partitions (401, 402, 403, 404) of the processing nodes (701, 702);
creating (1102) a sequence of range blocks (703, 704, 713, 714) on the local memory partitions of the processing nodes (701, 702), wherein each range block is configured to store data values falling within its range;
copying (1103) the plurality of sorted lists to the sequence of range blocks (703, 704, 713, 714) by deploying second processes on the processing nodes (701, 702), wherein each range block (703, 704, 713, 714) receives elements of the sorted lists which values are falling within its range;
sorting (1104) the elements of the range blocks (703, 704, 713, 714) locally per processing node (701, 702) by using the second processes to produce sorted elements on the range blocks (703, 704, 713, 714); and
reading (1105) the sorted elements from the sequence of range blocks (703, 704, 713, 714) sequentially with respect to their range to obtain the sorted input data.

2. The sorting method (1100) of claim 1,
wherein the local memory partitions (401, 402, 403, 404) of the plurality of interconnected processing nodes (701, 702) are structured as asymmetric memory.

3. The sorting method (1100) of claim 1 ,
wherein a number of first processes is equal to a number of local memory partitions (401, 402, 403, 404).

4. The sorting method (1100) of one of the preceding claim 1,
wherein the first processes produce disjoint sorted lists.

5. The sorting method (1100) of claim 1,
wherein the sorting the distributed input data locally per processing node (701, 702) is based on one of a serial sorting procedure and a parallel sorting procedure.

6. The sorting method (1100) of claim 1,
wherein a number of second processes is equal to a number of range blocks (703, 704, 713, 714).

7. The sorting method (1100) of claim 1,
wherein each range block (703, 704, 713, 714) has a different range.

8. The sorting method (1100) of claim 1,
wherein each range block (703, 704, 713, 714) receives a plurality of sorted lists, in particular a number of sorted lists corresponding to the number of first processes.

9. The sorting method (1100) of claim 1,
wherein a second process of the second processes running on one processing node (701, 702) reads sequentially from the local memory of the one processing node (701) and from the local memory of the other processing nodes (702) when copying the plurality of sorted lists to the sequence of range blocks (703, 704, 713, 714).

10. The sorting method (1100) of claim 9,
wherein the second process running on the one processing node (701) writes only to the local memory of the one processing node (701) when copying the plurality of sorted lists to the sequence of range blocks (703, 704, 713, 714).

11. The sorting method (1100) of claim 1,
wherein the sequential reading of the sorted elements from the sequence of range blocks (703, 704, 713, 714) is performed by utilizing hardware pre-fetching.

12. The sorting method (1100) of claim 1,
wherein the second processes use vectorized processing, in particular vectorized processing running on Single Instruction Multiple Data hardware blocks, for comparing values of the sorted lists with ranges of the range blocks (703, 704, 713, 714) and for copying the plurality of sorted lists to the sequence of range blocks (703, 704, 713, 714).

13. The sorting method (1100) of claim 1,
wherein the plurality of processing nodes (701, 702) are interconnected by intersocket connections; and
wherein a local memory of one processing node (701) is a remote memory to another processing node (702).

14. A processing system (100), comprising:
a plurality of interconnected processing nodes (101, 103) each comprising a local memory (107, 117) and a processing unit (109, 119), wherein input data is distributed over the local memories (107, 117) of the processing nodes (101, 103) and wherein the processing units (109, 119) are configured:
to sort (1001) the distributed input data locally per processing node (701, 702) by deploying first processes on the processing nodes (701, 702) to produce a plurality of sorted lists on the local memory partitions (401, 402, 403, 404) of the processing nodes (701, 702);
to create (1102) a sequence of range blocks (703, 704, 713, 714) on the local memory partitions of the processing nodes (701, 702), wherein each range block is configured to store data values falling within its range;
to copy (1103) the plurality of sorted lists to the sequence of range blocks (703, 704, 713, 714) by deploying second processes on the processing nodes (701, 702), wherein each range block (703, 704, 713, 714) receives elements of the sorted lists which values are falling within its range;
to sort (1104) the elements of the range blocks (703, 704, 713, 714) locally per processing node (701, 702) by using the second processes to produce sorted elements on the range blocks (703, 704, 713, 714); and
to read (1105) the sorted elements from the sequence of range blocks (703, 704, 713, 714) sequentially with respect to their range to obtain the sorted input data.

15. A computer program product comprising a readable storage medium storing program code thereon for use by a computer, the program code sorting input data distributed over local memory partitions of a plurality of interconnected processing nodes, the program code comprising:
instructions for sorting (1101) the distributed input data locally per processing node (701, 702) by deploying first processes on the processing nodes (701, 702) to produce a plurality of sorted lists on the local memory partitions (401, 402, 403, 404) of the processing nodes (701, 702);
instructions for creating (1102) a sequence of range blocks (703, 704, 713, 714) on the local memory partitions of the processing nodes (701, 702), wherein each range block is configured to store data values falling within its range;
instructions for copying (1103) the plurality of sorted lists to the sequence of range blocks (703, 704, 713, 714) by deploying second processes on the processing nodes (701, 702), wherein each range block (703, 704, 713, 714) receives elements of the sorted lists which values are falling within its range;
instructions for sorting (1104) the elements of the range blocks (703, 704, 713, 714) locally per processing node (701, 702) by using the second processes to produce sorted elements on the range blocks (703, 704, 713, 714); and
instructions for reading (1105) the sorted elements from the sequence of range blocks (703, 704, 713, 714) sequentially with respect to their range to obtain the sorted input data.
